(19) United States
(12) Patent Application Publication
(10) Pub. No.: US 2004/0059588 A1
(43) Pub. Date: Mar. 25, 2004

(54) Method of managing a project

(76) Inventors: David B. Burritt, Morton, IL (US); Stacy E. Smith, Washington, IL (US); Phillip A. Weingart, Metamora, IL (US); Martha J. Zimmerman, Avon, IL (US)

Correspondence Address: CATERPILLAR INC., 100 N.E. ADAMS STREET, PATENT DEPT., PEORIA, IL, 616296490

(21) Appl. No.: 10/264,579

(22) Filed: Oct. 4, 2002

Related U.S. Application Data
(60) Provisional application No. 60/412,104, filed on Sep. 19, 2002.

(51) Int. Cl. G06F 17/60

(52) U.S. Cl. 705/1; 705/7

(57) ABSTRACT

The present disclosure is associated with a method of managing a process associated with continuous improvement. In one embodiment, the method includes the steps of establishing multiple processes of an organization, evaluating a risk to the processes due to the project, and managing the project in response to the evaluation.

This application claims the benefit of prior provisional patent application serial No. 60/412,104 filed Sep. 19, 2002.

### TECHNICAL FIELD

The present invention relates generally to a method of managing a project, and more particularly to a method of managing a project associated with process improvement.

### BACKGROUND

Many corporations are implementing continuous improvement programs in an effort to improve the processes of the corporation. These process improvements are intended to ultimately help achieve the corporate objectives and goals. By their very nature, the processes that are implemented under these programs introduce change to the corporation. Process change within a corporation may also introduce risk into the corporation. While not all risk is inherently bad, assuming risk without understanding the significance of the risk, or being aware of the presence of the risk at all may lead to poor business decisions. That is, the processes introduced to help achieve corporate goals, may be the very processes that prevent the accomplishment of the goals, if the associated risks are not understood.

In addition, some corporations adopt a continuous improvement technique throughout the company on a whole scale basis, i.e., as a company wide initiative. This leads to concurrent improvement teams, and a significant cultural shift in the company. These changes in culture, and inherent changes in processes lead to the introduction of risk that may not have been previously present. Again, if a company is unaware of these risks, or their significance, then the desired improvements may not be realized.

The present invention is directed to overcome one or more of the problems set forth above.

### SUMMARY OF THE INVENTION

In one aspect of the present invention, a method of managing a project associated with process improvement is disclosed. The method includes the steps of establishing a plurality of processes of an organization, evaluating a risk to the processes due to the project; and managing the project in response to the evaluation.

In another aspect of the present invention, a method of managing a project associated with process improvement is disclosed. The method includes the steps of establishing a plurality of customer requirements, establishing a plurality of business objectives, establishing a business risk associated with the project, and managing the project in response to the customer requirements, the business objectives, and the business risk.

### BRIEF DESCRIPTION OF THE DRAWINGS

FIG. 1 is an illustration of one embodiment of a method of managing a project associated with process improvement; and

FIG. 2 is an illustration of one embodiment of a risk map.

### DETAILED DESCRIPTION

The present disclosure is associated with a method of managing a project associated with process improvement. There are many types of process improvement methods, such as continuous quality improvement, business process re-engineering, value based management, total quality improvement (or management), and 6 Sigma. An organization may determine to perform one or more projects utilizing one of the above process improvement methods, in an effort to enhance their ability to achieve their business objectives/goals. An organization may be described as a business, entity, corporation, company, or portion thereof, e.g., department etc. The project to be managed may be a new process being proposed, a new process slated for implementation, or an existing process being reviewed for modification.

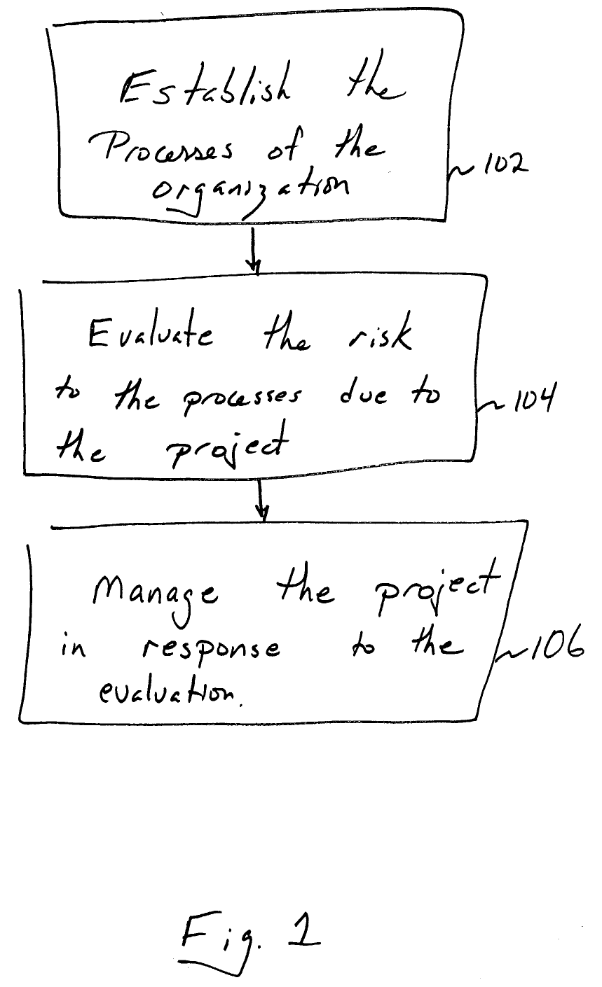

FIG. 1 illustrates one embodiment of a method of managing a project associated with process improvement. In a first control block 102 the processes of an organization are established. The processes may be general processes, or the key processes or key business activities of the organization. Key processes are major business processes and activities that the organization undertakes to ensure achievement of the organization's objectives. Examples of key processes (or key business activities) include: social responsibility, corporate governance, strategic business planning, product and/or service development, sales capability/customer relationship management, order fulfillment, product and service support, information management, financial products, accounting and reporting, human resources, and treasury. Key processes may vary from one organization to another. The key processes of the organization may have been previously established. For example, the key processes of a company may be established by top managers of a company and passed downward to other process layers and/or functional areas (e.g. departments) within the company. Alternatively the key processes may be established by the department managing the project, independent of key processes in other departments. In one embodiment, the key processes identified at an upper tier of an organization may be passed down and used as a baseline for key processes of the lower tier. The baseline key processes may then be customized by the lower tier, to reflect the goals/objectives of the lower tier. The customized processes may include sub-processes or inter-related processes of the key process.

In a second control block 104, the risks to the established processes due to the project, are evaluated. When a new project is created, or an existing project is modified, there is a change in the environment the project is established in. There are risks associated with this project regarding how the change will affect the organization's other processes, such as the key processes. In addition, there may be other processes which support, or relate to a particular key process (e.g., a sub-process or an inter-related process), and that are affected by the proposed project. Therefore, the risk to the established processes, such as the key process, and/or associated sub-processes and inter-related processes, may be evaluated in light of the project. Sub-processes and inter-related processes may also be referred to as supporting processes. A risk evaluation may include the identification of risk associated with a process (e.g., a key process and/or supporting process), and the assessment of risk associated with a process due to the proposed project. Risk identification is the process of identifying the risk associated with a process due to the project. The specific risk identification process used is implementation dependent and will be discussed below.

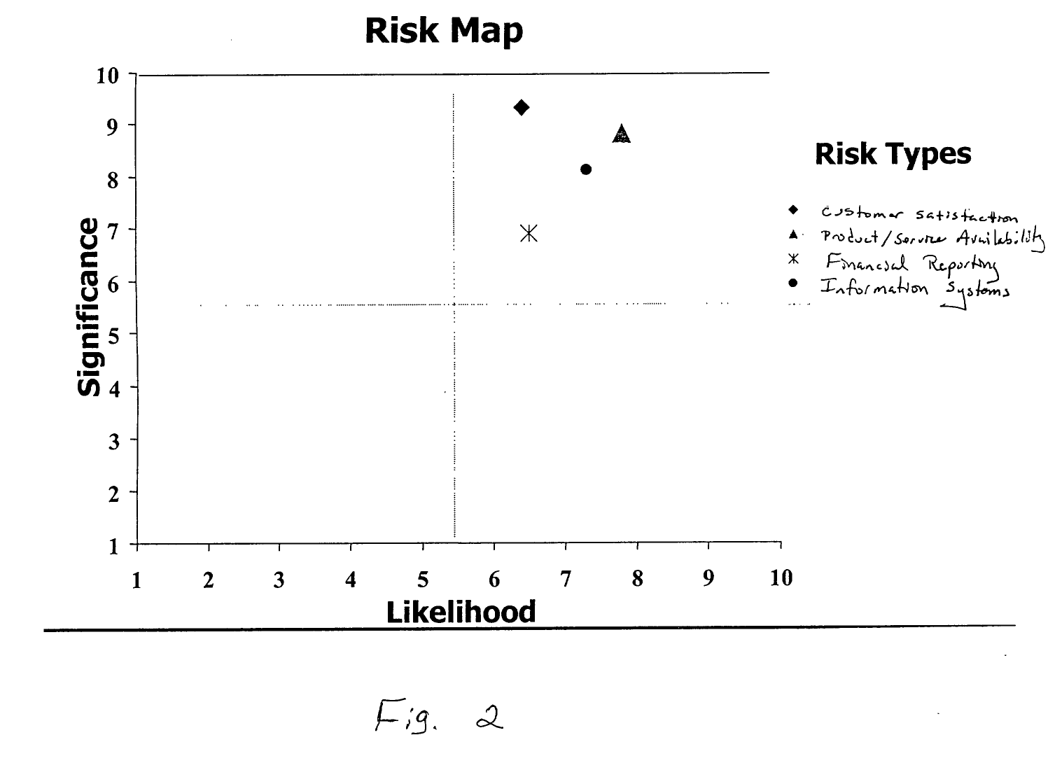

A risk assessment may include establishing a risk value (or score) indicative of the assessed risk to the key processes or associated supporting processes due to the project. For example, a value range may be established between 0 and 10, with 0 being indicative of the most risk, and 10 being indicative of the least risk. If the project will introduce unacceptable risk in the key process, or one or more of the supporting processes, then it may be assigned a value of 0. If the project will have a significant impact on the key process, or most of the supporting processes, it may be assigned a value of 1. If the project will have a moderate impact on some of the key process, or one or more supporting processes, then it may be assigned a value of 3. If the risks resulting from the project will have no or little impact on the key processes, or the supporting processes, then the value may be 10. The assignment of the risk values may be made by the project participants. In one embodiment, the participants make an estimate of the risk value. The value estimate may be performed without a specific risk identification process. That is, the risk value estimate may be an estimate of a perceived risk. In another embodiment, the project participants may vote on the significance of the risk and likelihood of the risk to occur. The voting may result in values (e.g., 1-10) being assigned to the significance and likelihood of the risk, as illustrated in FIG. 2 (an illustration of a risk map). From these values, a risk value may be established. For example, a risk value may be a weighted combination of the significance and likelihood of the risk.

In one embodiment, the risk value may be determined based on an inherent risk value and a residual risk value. An inherent risk value is an assessment of the risk associated with the key business process without considering existing activities or processes to minimize or mitigate the risk. The residual risk is the exposure to uncertainty remaining after considering current risk management activities or processes intended to mitigate or minimize the risk. The inherent risk value and residual risk value may be established by the project participants and/or through a self-assessment performed by the organization engaged in the project. A self-assessment is a process where the organization performs a risk review to identify and assess the risk associated with a process. There may be an inherent risk and residual risk associated with each of the key processes, and/or the associated supporting processes. The inherent and residual values may be based on the significance and likelihood of the risk. The inherent risk value and residual risk value may then be compared to determine an assessed risk to each of the key processes of the organization due to the project, and therefore, the assessed risk to the organization due to the project. For example, using a scale of 1-10 with 1 being low risk and 10 being high risk: if a risk associated with a key process has an inherent risk of 10, and a residual risk of 9, the assessed risk may be high (there is a large inherent risk associated with the key business activity and there is very little done, or done effectively, to mitigate the risk, therefore there is a high risk). If the inherent risk is 10 and the residual risk is 3, the assessed risk may be low (there is a large inherent risk associated with the key business activity, but the organization is effective at managing the risk, therefore the assessed risk is low). The inherent, residual, or assessed risk may form the basis for the risk values of the key processes impacted by the project.

In one embodiment, a risk value is associated with each of the established processes, e.g., key processes or associated sub-processes, or interrelated processes. Then a composite risk of the project on the key processes may be established in response to the risk values. The composite risk value may be established by adding each of the risk values together. The composite risk may then be used, in part, to manage the project, as will be discussed.

In one embodiment, a subset of the established processes is used to establish a composite value. The processes most impacted by the project may be identified, and the associated risk values used to determine the composite risk of the project. For example, a risk value may be established for each key process, or sub-process and/or inter-related process. Then the lowest four risk values, for example, may be used to establish the composite risk value.

In one embodiment, the risk assessment may be performed by utilizing multiple composite scores. That is, a composite score may be established using the risk values of the established processes most impacted by the project, as described above. In addition, a composite score may be established using the risk values of all of the established processes, as described above. Using both composite scores enables the assessment to identify if there are processes that will be significantly impacted by the project, and the overall risk to the process from the project.

In one embodiment, as mentioned above, the key processes may have associated sub-processes or inter-related processes. The supporting processes may be assessed with respect to risk. For example, a risk value may be determined and associated with each supporting process. The risk values of the supporting processes may be utilized to establish a composite value associated with the key process. The composite value of the supporting processes may be established in one of the embodiments described above. The risk value of the key process may be established, at least in part, based upon the composite risk value of the supporting processes.

In a third control block 106, once the project risk has been evaluated, the project may be managed in response to the evaluation. Project management may include using the evaluation to perform project selection, team selection for the project, determine the frequency of risk evaluations, and/or establish the level of integration with the continuous improvement process.

The risk values determined during the assessment may be used to guide project management. As discussed, the risk values associated with the processes may be added together to establish the composite value. In one embodiment, a composite value indicating a high risk, i.e., that the project may have a significant impact (and/or likelihood of occurring) on the processes, may be used to determine that the project should either not be implemented, or should utilize extensive risk management techniques throughout all steps of the project development, implementation, deployment, and monitoring, in order to manage the risk. A moderate composite risk value indicates that the project has a moderate impact on the processes, and therefore should utilize risk management during the initial steps of the project such as identification of customer requirements, and at specified checkpoints throughout the project. A composite value indicating a low risk, i.e., the project has a minimal impact on the processes, may be used to determine that the project should utilize risk management during identification of the critical customer requirements and review of the process decision.

Project management may include deciding whether to begin the project. Therefore, if the project has not begun, the risk assessment may be used to determine whether the project should proceed. If the risk assessment indicates that this project introduces too much risk to other processes, (e.g., based on the composite value) the project may be terminated before it is begun. Alternatively, aspects of the project may be identified through the risk evaluation, which if modified, would reduce the risk to existing processes.

The project may be managed by using the results of the risk assessment to select team members for the project, or to select a review team. For example, if there is a high risk of a process due to the proposed project, a subject matter expert associated with the effected process may be identified and consulted with. The subject matter expert may become part of the project team or part of a review team. The activities of the subject matter expert may include a further assessment of the risk to the effected process, to verify the initial risk assessment if there was one. In addition, the subject matter expert may identify potential risk mitigation processes. The subject matter expert may be involved throughout the phases of the proposed project to continue to assess the risk to the effected process and identify and assess potential mitigation activities.

Managing a project may include determining the timing/frequency of the risk evaluations. That is, the timing of the risk evaluation may vary. A risk assessment may be performed prior to beginning a project. In addition, subsequent risk assessments may be performed throughout the development, implementation, and deployment of a project. In one embodiment, the frequency of the risk assessments may be determined in response to the composite value of one or more assessments. For example, a decision to perform less frequent risk assessments may be made in response to the initial risk assessment indicating there is a low risk associated with the proposed project. If the first risk assessment indicates that there is a high risk to existing processes based on the project, then there may be a determination to perform risk assessments throughout the life of the project in an effort to monitor, control and mitigate the impact of the project on existing processes. If subsequent composite risk values indicate the risk is not as significant as previously assessed, then the frequency of the risk assessments may be reduced. In addition, if subsequent composite risk values indicate the risk is more significant than previously assessed, then the frequency of the risk assessments may be increased, and/or additional risk mitigation processes pursued.

The risk evaluation may be used to determine to what extent mitigation processes need to be pursued. In one embodiment, a composite risk value indicating a high risk may be used to determine that additional efforts should be made to mitigate the risk. For example, a review of possible processes that may be used to mitigate the risk of the project (and in particular the risk to the process due to the project) may be reviewed. One or more mitigation processes may be selected for implementation, in order to reduce the residual risk of the project. For example, one mitigation process may be the procurement of insurance (if available). The degree of risk introduced may help determine the amount of insurance purchased.

Risk assessments may be performed on projects that are already underway, e.g., that are being deployed. The purpose is to identify risk as soon as possible, even if the project is underway, or completed, in an effort to reduce the impact to the organization (e.g., increase the likelihood of success of the project etc.)

The project may be managed by using the risk evaluation to manage the level of integration there is between risk management and the continuous improvement process. For example, the higher the risk, the more frequently the risk evaluations may be performed during project implementation. Therefore, an integrated method of managing a project associated with process improvement may include the steps of establishing a plurality of customer requirements, establishing a plurality of business objectives, establishing a business risk associated with the project, and managing said project in response to the customer requirements, the business objectives, and the business risk.

Once a project has been selected for evaluation and/or implementation (e.g., a recognized need exists, and the project proposes to identify and implement a solution to the need), the customer requirements associated with the project may be established. The customer requirements may include performance standards and requirement statements. In one embodiment, customer requirements are obtained by identifying a problem to be solved (the need). Then the customer associated with the problem may be identified. Coordination with the customer then leads to the identification of customer criteria (or requirements). Customer coordination may include an interview with the customer(s) to determine whether current processes meet the customer requirements. If the current processes don't meet customer requirements, then a determination is made as to where they fall short. Other forms of customer coordination include surveys and small group meetings. The particular technique used to gather customer requirements is implementation dependent. The customer requirements may be prioritized and evaluated with regard to a business strategy.

The business objectives associated with the project may be established. In one embodiment the business objectives may be established by correlating the key business activities, or processes, of the organization with the particular project. That is, the key processes that are affected by the project being considered (or problem being considered) may be determined. These identified key processes may be considered the business objectives of the project. In addition, coordination with the customer may further establish the business objectives. The customers may be associated with different processes/functions of the organization. Therefore, the customers may have additional business objectives associated with the project, or provide additional information on how the project impacts other key processes.

The business risk associated with the project may be established. The business risk may be established as described above during the risk evaluation. For example, the risk may be established based upon establishing a risk value associated with the processes impacted by the proposed project, and developing a composite risk value in response to the risk values.

The project may then be managed in response to the customer requirements, business objectives, and business risk associated with the project. As mentioned, the project may be managed by determining how often to perform risk evaluations. In addition, the risk evaluation (e.g., composite values) may be used to determine what, if any controls or risk management processes should be put into place. A high risk may indicate that significant effort should be placed in identifying, assessing, and implementing risk mitigation processes.

Project management may include assessing the risk/benefit of a project or proposed mitigation process and managing it accordingly. The risk and benefit of the project may be balanced. That is, an assessment of whether the cost (risk) of the project, or associated mitigation process, is worth the potential benefit. In addition, the risk/benefit analysis may provide guidance on which risk mitigation processes should be implemented. If multiple risk mitigation processes are available, they may each be reviewed to determine the associated cost and benefit. Therefore, an informed decision may be made regarding which risk mitigation process(es) should be implemented. For example, if the risk of the project is that $100,000 will be lost in inventory, the risk mitigation process to reduce the risk of lost inventory should not itself cost $2,000,000 to implement.

In addition, as mentioned, managing the risk may include using the assessed risk to determine how frequently to perform a risk review (e.g., how thoroughly to integrate risk management with the continuous improvement process). For example, if the continuous improvement process associated with the process is 6 Sigma, then the project may be managed by integrating the risk management process into one or more phases of the DMAIC (define, measure, analyze, improve, and control) process or the DMEDI (define, measure, explore, develop, and implement) process.

The define phase of the DMAIC process includes defining the customers and their requirements, and mapping the process to be improved. During the define phase, risk management issues (such as the commitment to assess and manage risk) may be included in the problem statement and accounted for in the process mapping.

The risk evaluation process may also be utilized during the measure, analyze, improve and control phases of the DMAIC process. The measure phase includes the identification of existing process and performance standards, the collection of data on the process, determination of the process's baseline performance, and setting the improvement goal for the project. In one embodiment, a risk identification and assessment may be performed during the measure phase to understand what risk may be associated with the current process and what is the significance and likelihood of the risk, the inherent risk and residual risk of the process. This may be viewed as a baseline risk assessment. The manner in which a baseline risk assessment may be used is discussed below.

The analyze phase of the DMAIC process includes the identification of key sources of variation associated with the current and proposed processes, by analyzing the data and processes. In addition, the financial opportunity of the process may be quantified. The baseline risk assessment established during the measure phase, may be used as potential solutions are posed, in order to compare the risk of the current process, with the risk of the proposed project/process. An increased risk associated with a proposed process is not inherently bad, if there are appropriate risk mitigation processes available, or if the benefit associated with the proposed process warrants the risk. However, having the baseline risk assessment enables these considerations to be analyzed and accounted for.

The improve phase of the DMAIC process includes the generation and testing of possible solutions, leading to the selection of the best solution (e.g., process modification or creation) to address important sources of variation. In addition, the required resources are identified, and the implementation plans are developed. Performing risk evaluation during this phase enables the identification and assessment of risk associated with the new process or the update of the risk assessment if it was performed earlier. This evaluation enables an assessment of the risk of the possible solutions, and a comparison of the risk with each other and with the baseline risk assessment. Therefore, there is an understanding of what the risks are, what the significance and likelihood of the risks are, and how the risks may be managed with regard to the potential solutions, and the solution ultimately selected. In addition, the risk assessment enables plans to be generated on how to further manage the risks.

The control phase includes implementing the proposed project or project improvement and implementing a plan for sustaining the improvement. Risk management assessments may be used during this phase to monitor the risk associated with the new process. The risk assessment may be performed to see if the risks were expanding and contracting. The assessment will enable the assessment of risk mitigation processes. For example, if one mitigation process is turning out to be ineffective, an alternative mitigation process may be pursued. In addition, risk may be greater than anticipated in some areas, thereby warranting additional mitigation processes, etc. Analogous risk management activities may be used with the DMEDI (define, measure, explore, develop, and implement) phases of 6 Sigma.

As mentioned, the risk evaluation may include the process of risk identification. The process of identifying risk may be performed in several ways. In one embodiment, risk identification involves the team associated with the project using their judgment to determine which key processes may be impacted by the project, and then determining an associated risk value for each of the key processes during the risk assessment. Alternatively, the team may identify the potential for the project to effect a key process, sub-process, or inter-related process, and then identify a subject matter expert associated with the effected process. The subject matter expert may then perform a further review and establish a risk value.

In one embodiment, risk identification may be performed by comparing the proposed process/project with previously reviewed processes. For example, a repository of processes/projects associated with risk evaluations, may be maintained. Therefore, the currently proposed project may be compared with the repository to determine if there have been any similar/analogous projects/processes evaluated (or reviewed). If there have been, then the risk identified with the reviewed process may be considered to determine if they are also risks for the proposed process. In this manner, previous risk evaluations may be used to provide guidance on what risk may be applicable to the proposed process, what key processes, sub-process, or inter-related processes may be effected by the risk and to what degree (e.g., significance and likelihood), and what are potential mitigation processes. While risk evaluations, including the risk, process impact, and mitigation processes of a project, vary from one proposed project to another, the findings of the risk evaluations may be applicable for similar/analogous processes/projects, and therefore beneficial to review.

In one embodiment, the repository of process reviews may be maintained in a project tracking (or cataloguing) system. A tracking system may contain all of the continuous improvement projects, regardless of the stage of the project. The tracking system may enable the categorizing of projects by key process areas. For example, a project associated with inventory management may be located under a category of order fulfillment. Cataloguing projects by key processes may enhance the ability to quickly identify analogous projects and leverage the risk evaluations performed for the analogous projects. In addition, using key processes to catalogue continuous improvement projects creates a common, unifying framework for the company. That is, the key processes have been identified that relate directly to the organization's business objectives and goals. Using these key processes to catalogue continuous improvement projects helps ensure that proposed projects are directed towards the areas the organization has deemed key for success. Therefore, if resources are limited, the activities may be focused in the areas deemed most important. In addition, the manager of the continuous improvement process may be on an organization's risk management committee (or vice versa) to further ensure the integration of risk management and continuous improvement projects. In one embodiment, the project tracking system may be searched based on one or more of: project, key process, risk (or risk type), and mitigation processes.

In one embodiment, the risk identification process may include a formal risk identification phase. For example, a risk management team may engage in interviews with the identified participants of the organization to identify the risk. The interviews are conducted to identify the risk that may be associated with the project being reviewed. For example, risks which cause variability in the processes associated with the project may be identified. In one embodiment, only one individual is met with at a time. In this manner an individual's opinions regarding the risk associated with the process may be more forthcoming. In addition, the interview results associated with the individual are recorded anonymously, again to encourage more forthcoming responses. In one embodiment, interview comments are correlated with risk types, during, or immediately following the interview, to facilitate rapid identification of applicable risks. Risk types are baseline types of risks that may impact the company and/or the organization. Generally, only a subset of the risk types will be applicable to any particular process. The applicable risk types are determined on a process by process basis. In one embodiment, the baseline risk types may be determined by an upper tier of the company, and passed downwards. In one embodiment, if the baseline list of risks is not comprehensive, risks other than the baseline risk types may be identified as potentially applicable to the process. Therefore the interview comments may be correlated with the risk types during the interview to facilitate rapid identification of applicable risks. While the interview format is implementation dependent, the interview may begin with an initial discussion of the project (or process) and the interviewee's role in the project. The initial discussions may be followed by detailed questions regarding the risk the individual believes to be associated with the project, why the individual believes these to be risk associated with the project, what the significance of the risk is, what priority the individual assesses to the risk, and other types of follow-up questions. In one embodiment, the root cause (perceived or otherwise) of the risk may be discussed. That is, issues such as why the risk exists, what causes the risk to exist, what factors contribute to changes in the risk, etc., may be discussed. In one embodiment, the interviewer may also identify any known processes that may be used to mitigate the identified risk, the effectiveness of the mitigation processes, and the maturity of the mitigation processes.

Other aspects, objects, and advantages of the present invention can be obtained from a study of the drawings, the disclosure, and the claims.

### INDUSTRIAL APPLICABILITY

The present disclosure is associated with a method of managing a process associated with continuous improvement. In one embodiment, the method includes the steps of establishing multiple processes of an organization, evaluating a risk to the processes due to the project, and managing the project in response to the evaluation. An example of a proposed project may include a new purchasing system associated with inventory management. In one embodiment the project may have begun by identifying a problem associated with the purchasing process. For example, payments associated with invoices are repeatedly late, payment amounts are in error, and sometimes go to the wrong company. Therefore, there is a need to improve the purchasing process. The proposed purchasing system may be one of the results of the investigation into the need to improve the purchasing process (e.g., the identification of customer requirements and associated business objectives).

The process (e.g., key or supporting process) of the organization may be established. For the sake of this example, assume an upper tier of the organization has established the key processes and distributed them throughout the company. The key processes established may include: social responsibility, corporate governance, strategic business planning, product and/or service development, sales capability/customer relationship management, order fulfillment, product and service support, information management, financial products, accounting and reporting, human resources, and treasury.

The risk associated with the key processes due to the proposed project may be evaluated. For example, a risk value may be established to reflect the risk of the project to the process. The risk values may range from 0-10, with 0 being indicative of the most risk, and 10 being indicative of the least risk. The evaluation may result in the following assessment:

| | | Process Impact |
|---|---|---|
| Process | | (Risk Value) |
| 1) | Social responsibility | 9 |
| 2) | Corporate governance | 9 |
| 3) | Strategic business planning | 9 |
| 4) | Product and/or service development | 4 |
| | (An ineffective purchasing process may impact | |
| | the selling of inventory management services) | |
| 5) | Sales capability/customer relationship management | 3 |
| 6) | Order fulfillment | 1 |
| | (Purchasing is a significant aspect of order | |
| | fulfillment) | |
| | (An ineffective purchasing process will | |
| | significantly impact customer relationships) | |
| 7) | Product and service support | 4 |
| 8) | Information management | 9 |
| 9) | Financial products | 9 |
| 10) | Accounting and reporting | 3 |
| | (Inadequate record keeping will adversely | |
| | impact accounting and reporting) | |
| 11) | Human resources | 9 |
| 12) | Treasury | 1 |
| | (Late payments and finance charges impact cash) | |

Adding the risk values together results in an overall composite value of 70 (out of 120), with an average risk value of 5.8. The overall composite score indicates that the proposed process will have some impact on some of the processes. Therefore, additional risk management steps should be implemented (e.g., have additional risk assessments at the beginning and ending phase of the DMEDI/DMAIC process). However, the focused composite value (as determined by adding the four lowest risk values together) is 8, with an average risk value of 2. Based on a composite threshold of 0-12 indicating high risk, 13-24 indicating moderate risk, and 24-36 indicating low risk, this particular proposed project poses a high risk to the key processes, or at least a significant portion of them. Therefore, despite the moderate to low risk indicated by the overall composite value, the process should be deemed to pose high risk based on the focused composite value. Accordingly several actions may be taken to manage the project. These actions may be done concurrently or sequentially. In one embodiment, a decision regarding whether to proceed any further with the project may be made. It may be determined that the assessed risk is larger than desired, and therefore the project will not proceed. The assessed risk may be based on the focused composite value, average focused risk values, the overall composite values, the overall risk values, or some combination thereof. A risk/benefit analysis may be performed to assist in determining whether to proceed. For example, a detailed analysis of the risk to Sales Capability/Customer Relationship Management, Order Fulfillment, Product and Service Support, Accounting and Reporting and Treasury may be performed (if it hasn't been already), along with a detailed analysis of the benefits of the proposed process. Then a risk/benefit analysis may be performed to determine the acceptable amount of risk to be assumed, in light of the associated benefits. If the benefits of the proposed purchasing system do not offset the assessed risk or cost, then the project may be cancelled.

Subject matter experts may be identified in each of the areas perceived to be significantly impacted (e.g., Sales Capability/Customer Relationship Management, Order Fulfillment, Accounting and Reporting, and Treasury). These subject matter experts may be included on the team (if they haven't been already), or may simply perform an oversight/consulting role for the team. The subject matter expert may perform a more in-depth assessment of the risk to the process. In addition to identifying a subject matter expert, risk mitigation processes may be identified and assessed to try and offset the assessed risk. For example, the risk mitigation processes may include: operating the existing purchasing process in parallel with a proposed process before pulling the current process offline and exercising the proposed process with purchasing data before activating the process.

If the project is to proceed, then the frequency of risk reviews may be determined based on the risk assessment (e.g., utilizing focused composite values). In this case, with a high risk assessment, plans may be made to review the risk at each of the phases of the continuous improvement process (e.g., DMAIC or DMEDI phases in the case of 6 Sigma). In this manner additional scrutiny may be provided to proposed projects that have high risk assessments. Therefore, the assessed risk may be reduced, or at least controlled and balanced with the anticipated benefits of the process.

What is claimed is:

1. A method a managing a project associated with process improvement, comprising the steps of:
establishing a plurality of processes of an organization;
evaluating a risk to said processes due to said project; and
managing said project in response to said evaluation.

2. A method, as set forth in claim 1, wherein the step of establishing said risk further includes the step of establishing an impact of said project on said processes.

3. A method, as set forth in claim 2, wherein the step of establishing said impact further comprises the steps of:
establishing a composite impact on said processes; and
establishing said impact in response to said composite impact.

4. A method, as set forth in claim 2, wherein the step of establishing said impact further comprises the steps of:
selecting a portion of said processes; and
establishing said impact in response to said selected portion of said processes.

5. A method, as set forth in claim 4, wherein said selected portion of said processes are identified as being impacted the most by said project.

6. A method, as set forth in claim 5, wherein said project is a 6 Sigma project.

7. A method, as set forth in claim 4, further comprising the steps of:
establishing a composite impact of said selected portion; and
establishing said impact in response to said composite impact.

8. A method, as set forth in claim 7, further comprising the step of classifying said impact as one of a plurality of impact types, in response to said composite impact.

9. A method, as set forth in claim 7, wherein the step of managing said project further comprises the steps of:
determining whether to begin said project in response to said established business risk.

10. A method, as set forth in claim 7, wherein the step of managing said project further comprises the steps of modifying said project in response to said established business risk.

11. A method, as set forth in claim 7, wherein said establishment of said business risk occurs prior to a beginning of said project.

12. A method, as set forth in claim 11, further comprising the step of re-evaluating said established business risk during said project.

13. A method, as set forth in claim 7, wherein said establishment of said business risk occurs during said project.

14. A method, as set forth in claim 7, wherein said project is a 6 Sigma project.

15. A method, as set forth in claim 14, wherein said business risk is established during at least one of a define phase, a measure phase, an analyze phase, an improve phase, and a control phase of said 6 Sigma project.

16. A method, as set forth in claim 1, wherein the step of managing said project further comprises the step of:
selecting a project team member in response to said risk evaluation.

17. A method, as set forth in claim 1, wherein the step of managing said project further comprises the step of:
identifying a subject matter expert in response to said risk evaluation.

18. A method, as set forth in claim 1, wherein the step of managing said project further comprises the step of:
determining a frequency of additional risk evaluations in response to said risk evaluation.

19. A method, as set forth in claim 1, wherein the step of managing said project further comprises the step of:
establishing a level of integration with a process improvement method, in response to said risk evaluation.

20. A method of managing a project associated with process improvement, comprising the steps of:
establishing a plurality of customer requirements;
establishing a plurality of business objectives;
establishing a business risk associated with said project; and
managing said project in response to said customer requirements, said business objectives, and said business risk.

21. A method, as set forth in claim 20, wherein the step of establishing a business risk further comprises the steps of:
establishing a plurality of key business activities;
establishing an impact of said project on said key business activities; and
establishing said business risk in response to said impact.

22. A method, as set forth in claim 21, wherein the step of establishing said impact further comprises the steps of:
establishing a composite impact of said key business activities; and
establishing said impact in response to said composite impact.

23. A method, as set forth in claim 21, wherein the step of establishing said impact further comprises the steps of:
selecting a portion of said key business activities; and
establishing said impact in response to said selected portion of said key business activities.

24. A method, as set forth in claim 20, wherein said selected portion of said key business activities are identified as having the most significant impact on said project.

25. A method, as set forth in claim 24, wherein said project is a 6 Sigma project.

26. A method, as set forth in claim 23, further comprising the steps of:
establishing a composite impact of said selected portion; and
establishing said impact in response to said composite impact.

27. A method, as set forth in claim 26, further comprising the step of classifying said impact as one of a plurality of impact types, in response to said composite impact.

28. A method, as set forth in claim 26, wherein the step of managing said project further comprises the steps of:
determining whether to begin said project in response to said established business risk.

29. A method, as set forth in claim 26, wherein the step of managing said project further comprises the steps of modifying said project in response to said established business risk.

30. A method, as set forth in claim 29, wherein said establishment of said business risk occurs prior to a beginning of said project.

31. A method, as set forth in claim 30, further comprising the step of re-evaluating said established business risk during said project.

32. A method, as set forth in claim 26, wherein said establishment of said business risk occurs during said project.

33. A method, as set forth in claim 26, wherein said project is a 6 Sigma project.

34. A method, as set forth in claim 33, wherein said business risk is established during at least one of a define phase, a measure phase, an analyze phase, an improve phase, and a control phase of said 6 Sigma project.
